(19) United States
(12) Patent Application Publication
(10) Pub. No.: US 2010/0148931 A1
(43) Pub. Date: Jun. 17, 2010

(54) RADIO DEVICES AND COMMUNICATIONS

(76) Inventors: Ravikanth Srinivasa Pappu, Cambridge, MA (US); Yael Gregory Maguire, Somerville, MA (US); Bernd Schoner, Cambridge, MA (US); Brian Fiegel, Iowa City, IA (US); Arun Viswanathan, Nashua, NH (US)

Correspondence Address: CHOATE, HALL & STEWART LLP, TWO INTERNATIONAL PLACE, BOSTON, MA, 02110, US

(21) Appl. No.: 12/333,988

(22) Filed: Dec. 12, 2008

(51) Int. Cl. H04Q 5/22

(52) U.S. Cl. 340/10.2

(57) ABSTRACT

Each of multiple radio devices in a region (e.g., a zone) receives time reference information for synchronizing themselves amongst each other. For example, based on the timing reference information, each radio device in a region synchronizes itself with respect to a common time reference, enabling communications according to shared access schedule (e.g., a time slotted access schedule). Each of the radio devices schedules communications to one or more target devices (e.g., RFID tags) in a monitored region based at least in part according to the shared access schedule. For example, each of multiple transmitters of the tag readers are assigned one or more time slots of the shared access schedule in which they are permitted to communicate in the monitored region.

### RELATED APPLICATION

This application is related to and claims priority to International Application PCT/US2007/013676 filed on Jun. 11, 2007 which claims priority to U.S. Provisional Patent Application Ser. No. 60/813,253 filed on Jun. 12, 2006, the entire teachings of which are incorporated herein by this reference in their entirety.

### BACKGROUND

Wireless tag readers are commonly used in industrial plants, warehouses, retail locations, hospitals, and within logistics operations to identify and track manufactured items. In such applications, a wireless identification tag such as an RFID (Radio Frequency Identification) tag is affixed to a monitored item such as a single packaged product or a bin or pallet containing multiple manufactured items. Typically, the wireless tag stores relevant data pertaining to and identifying the item to which it is affixed. As the wireless tag passes near a wireless tag reader, the tag reader communicates with the wireless tag to retrieve information pertaining to the tag itself and the tagged item.

Some wireless tags are ‘active’ in the sense that they include an antenna and transmitter capable of initiating wireless communication with a tag reader. Some active wireless tags contain only a radio transmitter, while others include a radio receiver, and still others might include both a transmitter and a receiver. The tag may generate its own signal, or it may “backscatter” modulate the reader's transmitted signal. Active wireless tags include a power source such as a battery to power their internal electronic circuitry and generate a wireless communication signal. Typically, because of this on board power source, active tags exhibit longer transmission range (called “read range”) than the passive tags described below.

In comparison to active tags, ‘passive’ wireless tags do not contain a power source and therefore they cannot independently generate a wireless signal to communicate with a tag reader or process digital information on their own. Instead, these passive devices rely on receiving power from an interrogating signal generated by a tag reader to power their internal circuitry. In the presence of the interrogation (or ‘powering’) signal, the passive tag devices are able to power themselves, retrieve data stored in their memory, and communicate the retrieved data to the tag reader. The amount of power that passive tags are able to recover from the reader's signal is generally small, so passive tags generally exhibit shorter transmission range (reduced “read range”) than active tags.

Certain passive tags include a resonant circuit or antenna tuned to a particular interrogation frequency of the tag reader. In such devices, the characteristics of the resonant circuit are altered via switching (e.g., switching a resistor, inductor, or capacitor in and out) to modulate a signal to a tag reader according to a stored data string associated with the tag. A modulated signal produced by switching is then re-radiated to the tag reader. The tag reader, in turn, processes the received data string associated with the tag to identify characteristics of the item or tag itself. In certain applications, the tags can store information received from the tag reader in a memory located on the tag.

In practice, tag readers are typically mounted at strategic locations in manufacturing and/or retail facilities to monitor a presence of wireless identification tags. Mounting tag readers at locations throughout a facility enables tracking movement of wireless tags and, thus, corresponding tagged items. The number of tag readers employed in a facility depends to some extent on the characteristics of the facility, as well as the operating characteristics of the tags (e.g., whether the tag is an active or passive tag, as well as on the tag's operating frequency). Specifically, applicable government radio regulations, tag type, and the size, shape and number of rooms and floors in a building are factors to consider when installing a tag monitoring system.

### SUMMARY

Unfortunately, there are deficiencies associated with conventional techniques of monitoring wireless identification tags. For example, a typical retail distribution center might comprise of several tens or even hundreds of adjacent inbound and outbound dock doors, each of which is outfitted with a distinct tag reader. As such, each of these readers may be required to read tagged cases and pallets passing through the dock door at any time, without prior notice. In such a scenario, conventional techniques of monitoring wireless identification tags rely on keeping all readers in a continuous monitoring mode. Such an approach is deficient in several ways. First, such an approach may be prohibited by local radio regulations. For example, in several countries of the European Union, wireless transmitting devices are required to monitor the available channels for the absence of other transmissions before transmitting on the channel themselves. If, as is typically the case, the number of channels is limited, and all the readers are continuously on, it is easy for a small group of readers to monopolize all available channels completely, thereby preventing any other readers within the distribution center from providing acceptable tag reading performance. In order to prevent this undesirable situation from occurring, the regulations typically prescribe a maximum duration of radio transmission before a given wireless transmitting device must seek a different channel before continuing its operation. This allows other transmitting devices the possibility of acquiring a channel and providing acceptable data transmission performance. However, it is well known in the art that the probability of a given wireless transmitting device acquiring a channel decreases exponentially with an increasing number of readers. By way of example, if there are 50 available channels, and there are more than 22 wireless transmitting devices within range of each other transmitting at random times, then the probability that any device will acquire an available channel is very close to zero. As mentioned above, it is not uncommon for a retail distribution center to exceed this number of tag readers by a large margin. Such a situation is clearly undesirable because it does not allow the tag readers to be ready to read tags that pass through the dock door at arbitrarily random times. It is therefore necessary to eliminate such channel collisions, and provide a guaranteed means for tag readers to access available channels and enable efficient utilization of the available spectrum.

It is an advancement in the art to provide a radio device and/or radio system that addresses these and other deficiencies associated with conventional wireless tag readers.

According to one configuration as described herein, a radio device such as a tag reader (e.g., an RFID tag reader and/or RFID tag reader system) communicates with one or more types of wireless identification tags in a monitored region. Each of multiple radio devices in a region (e.g., a zone) receives time reference information for synchronizing themselves amongst each other. For example, based on the timing reference information, each radio device in a region synchronizes itself with respect to a common time reference, enabling communications according to shared access schedule (e.g., a time slotted access schedule). Each of the radio devices schedules communications to one or more target devices (e.g., RFID tags) in a monitored region based at least in part according to the shared access schedule. As will be discussed, synchronizing the radio devices and/or use of the shared access schedule in this way enables a more efficient use of a wireless access channels because the communications from the tag readers are coordinated.

In one embodiment, a communication system includes two or more tag readers that communicate with corresponding RFID tags in a monitored region. The tag readers communicate from their corresponding transmitters based at least in part on a shared access schedule. For example, each of the tag readers receives synchronization information and utilizes the received synchronization information to synchronize a given RFID tag reader with a set of one or more other RFID tag readers. Each tag reader then initiates communications from at least one transducer (e.g., antenna, transceiver, transmitter, etc.) associated with the given RFID tag reader in assigned time slots of the shared access schedule.

Coordination of tag reader transmissions (on different transmitters) in different time slots can reduce an amount of interference among the tag readers. For example, as will be discussed in more detail below, each of the tag readers can include one or more multiple wireless transducers on which to transmit to RFID tags present in a monitored region. In addition to receiving synchronization information, the tag readers can receive antenna or transmitter assignment information indicating in which of multiple possible time slots of the shared access schedule that corresponding antennas associated with a given RFID tag reader are permitted to transmit in the monitored region.

The tag readers can utilize the assignment information to aid in creation of their own schedule for communicating with tags in a monitored region. For example, transmitters (e.g., antennas) of each tag reader are permitted to transmit in different assigned time slots as mentioned above. The tag readers can each create their own sub-schedules of communications for transmitting during assigned time slots. Accordingly, the tag readers support autonomous communications in the assigned time slots. In other words, each tag reader can schedule communications independent of other tag readers as long as they transmit from respective one or more transmitters in assigned time slots.

Embodiments herein can include additional functions such as the creation and distribution of the assignment information. For example, a scheduler function can receive transmitter information (e.g., information indicating which transmitters interfere with each other when activated at the same time) associated with multiple transmitters that transmit RF energy in a monitored region. Based on the transmitter information, the scheduler function produces assignment information by assigning each of the multiple transducers a respective time slot (of the shared access schedule) for permitting transmission of RF energy in the monitored region. The scheduler function and/or associated distribution function initiates distribution of the antenna or transmitter assignment information to (each of multiple tag readers to) provide notification of which of multiple time slots when each of the multiple transducers are permitted transmit the RF energy in the region. Depending on the embodiment, the antenna assignment information can be derived from a centrally located or distributed scheduler function.

As an alternative to receiving time slot assignment information from a remote source, in yet further embodiments, each of a set of tag readers in a monitored region can receive a set of rules for determining in which of multiple time slots they are permitted to transmit on their corresponding transmitters. In such an embodiment, the tag readers in a region synchronize themselves to a common time reference. Each of the tag reader receives a set of rules about use of a wireless spectrum to communicate from its multiple corresponding wireless transmitters (e.g., transmitters associated with the given RFID tag reader). In accordance with the received set of rules, each tag reader assigns its one or more transmitters one or more time slots (e.g., of the shared time-slotted access schedule) in which the transmitters can be activated to communicate in a monitored region. Accordingly, each tag reader need not rely on a remote function to identify in which time slots its corresponding transmitters are permitted to transmit.

In addition to the embodiments as discussed above, other embodiments disclosed herein include any type of computerized device, workstation, handheld or laptop computer, RFID tag reader device, scheduler, server, etc. configured with software and/or circuitry (e.g., a processor) to process any or all of the method operations disclosed herein. In other words, a computerized device or any type of processor that can be programmed or configured to operate as explained herein is considered an embodiment disclosed herein.

Other embodiments disclosed herein include software programs to perform the steps and operations summarized above and disclosed in detail below. One such embodiment comprises a computer program product that has a computer-readable medium including computer program logic encoded thereon that, when performed in a computerized device having a coupling of a memory and a processor, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained herein as embodiments disclosed herein.

In addition to the embodiments discussed above, other embodiments herein include a computerized device (e.g., a host computer, workstation, etc.) configured to support the techniques disclosed herein such as synchronizing tag readers and supporting time-slotted communications as described herein. In such embodiments, a computer environment to carry out the invention includes a memory system, a processor (e.g., a processing device), a respective display, and an interconnect connecting the processor and the memory system. If appropriate, the interconnect can also support communications with the respective display (e.g., display screen or display medium). The memory system can be encoded with an application that, when executed on a respective processor, supports database management according to techniques herein.

Yet other embodiments of the present disclosure include software programs to perform the method embodiment and operations summarized above and disclosed in detail below in the Detailed Description section of this disclosure. More specifically, one embodiment herein includes a computer program product (e.g., a computer-readable medium). The computer program product includes computer program logic (e.g., software instructions) encoded thereon. Such computer instructions can be executed on a computerized device to support parallel processing according to embodiments herein.

For example, computer program logic, when executed on at least one processor associated with a computing system, causes the processor to perform the operations (e.g., the methods) indicated herein as embodiments of the present disclosure. Such arrangements as further disclosed herein can be provided as software, code and/or other data structures arranged or encoded on a computer readable medium such as an optical medium (e.g., CD-ROM), floppy or hard disk, or other medium such as firmware or microcode in one or more ROM or RAM or PROM chips or as an Application Specific Integrated Circuit (ASIC). The software or firmware or other such configurations can be installed on a computerized device to cause one or more processors in the computerized device to perform the techniques explained herein.

Yet another more particular technique of the present disclosure is directed to a computer program product or computer environment that includes a computer readable medium having instructions stored thereon to facilitate carrying out of embodiments herein. For example, the instructions and corresponding execution by a processing device can support operations of: i) receiving time reference information; ii) based on the timing reference information, synchronizing the wireless transceiver device with multiple other wireless transceiver devices that communicate in the monitored region; and iii) scheduling communications from the given wireless transceiver device to at least one of the multiple wireless identification tags in the monitored region.

According to another embodiment, a radio device and/or radio communication system supports operations of: i) receiving synchronization information; ii) utilizing the synchronization information to synchronize a given RFID tag reader with a set of other RFID tag readers; and iii) initiating communications from at least one antenna associated with the given RFID tag reader in assigned time slots.

According to yet another embodiment, a radio device and/or radio communication system supports operations of: i) synchronizing a given RFID tag reader with at least one other RFID tag reader in a region, each RFID tag reader having at least one corresponding antenna to communicate in a region; ii) receiving antenna assignment information indicating in which of multiple possible time slots that corresponding antennas associated with the given RFID tag reader are permitted to transmit; and iii) utilizing the antenna assignment information to create an access schedule for the given RFID tag reader to communicate in the region.

According to yet another embodiment, a centrally located or distributed scheduler function supports operations of: i) receiving transmitter information associated with multiple transducers that transmit RF energy in a monitored region; ii) based on the transmitter information, producing assignment information by assigning each of the multiple transducers a respective time slot for permitting transmission of RF energy in the monitored region; and iii) distributing the antenna assignment information to provide notification of which of multiple time slots when each of the multiple transducers are permitted transmit the RF energy in the region.

According to still other embodiments, a radio device and/or radio communication system supports operations of: i) synchronizing a given RFID tag reader with other RFID tag readers; ii) receiving a set of rules about use of a wireless spectrum to communicate from multiple transmitters associated with the given RFID tag reader; and iii) in accordance with the set of rules, assigning the multiple transmitters of the given RFID tag reader to transmit in time slots of a shared time slotted access schedule, the shared time slotted access schedule used by the given RFID tag reader and the other RFID tag readers to communicate in a monitored region.

Other embodiments of the present disclosure include hardware and/or software programs to perform any of the method embodiment steps and operations summarized above and disclosed in detail below.

It should be understood that the system disclosed herein may be embodied strictly as a software program, as software and hardware, or as hardware alone.

Techniques herein are well suited for use in applications such as those supporting RFID communications. However, it should be noted that configurations herein are not limited to such use and thus configurations herein and deviations thereof are well suited for use in other environments as well. For example, as wireless devices continue to proliferate in home and office environments, the available wireless spectrum becomes congested, and the data transfer capability of any particular device suffers as a result. In such a scenario, the techniques disclosed herein can be employed to mitigate, or possibly eliminate, spectral congestion and provide a guaranteed opportunity for all devices to access available channels.

Another exemplary application area relates to wireless ad-hoc sensor networks. Such networks consist of a number of wireless sensors installed in a particular geographical area, such area being of varying sizes. Each sensor node possesses the ability to monitor some physical parameter in the vicinity. These parameters can be temperature, pressure, nuclear, radiological, biological, or explosive materials, humidity levels, and such like. Further, they also possess the ability to transmit this acquired data to each other as well as to a central base station. Because it is important to preserve battery life in such sensor networks, it is desirable for these wireless sensor nodes to be guaranteed access to a channel when they choose to communicate their data so that they can successfully complete their communication without requiring several re-transmission attempts. The techniques disclosed herein can help enable such guaranteed channel access.

Each of the different features, techniques, configurations, etc. discussed herein can be executed independently or in combination. Accordingly, the present invention can be embodied and viewed in many different ways.

Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details and/or possible perspectives (permutations) of the invention, the reader is directed to the Detailed Description section and corresponding figures of the present disclosure as further discussed below. Although not exhaustive, the claims section also provides different perspectives of the invention based on matter recited in the specification.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily drawn to scale, emphasis instead being placed upon illustrating the principles of the present invention.

FIG. 1 is an example block diagram of a communication system for monitoring one or more types of wireless identification tags according to embodiments herein.

FIG. 2 is an example block diagram of a communication system for monitoring one or more types of wireless identification tags according to embodiments herein.

FIG. 3 is an example diagram of a time-slotted schedule in which corresponding transmitters of tag readers are permitted to communicate in a monitored region according to embodiments herein.

FIG. 4 is an example diagram of a time-slotted schedule in which corresponding transmitters of tag readers are permitted to communicate in a monitored region according to embodiments herein.

FIG. 5 is an example diagram of a management system that generates and distributes transmitter assignment information according to embodiments herein.

FIG. 6 is an example diagram of tag reader generating its own transmitter assignment information according to embodiments herein.

### DETAILED DESCRIPTION

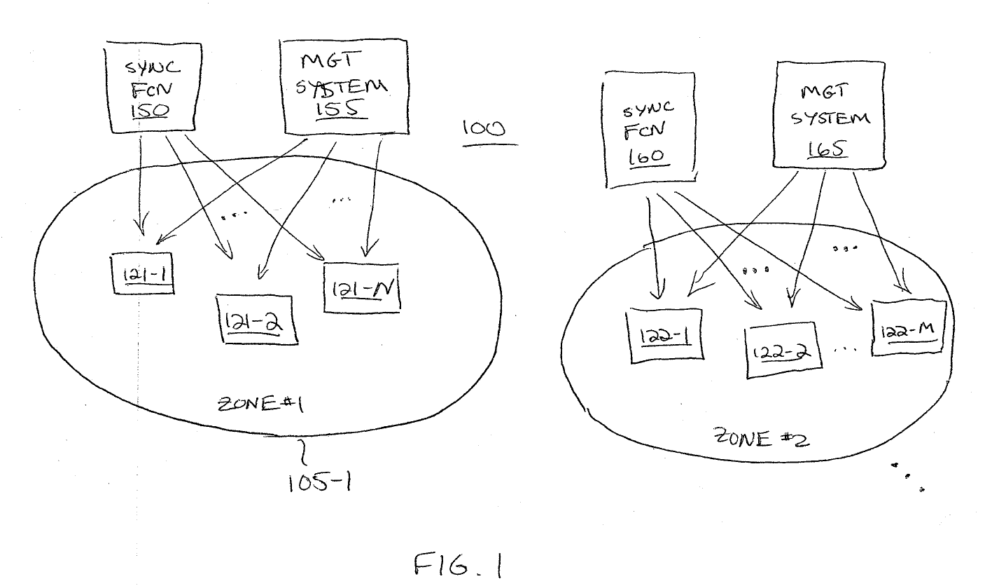

FIG. 1 is block diagram illustrating a technique of implementing non-interfering zones 105 of tag readers 121 according to embodiments herein. For example, communication system 100 includes any number of zones 105 (e.g., zone 105-1, zone 105-2, . . . ) of interfering tag readers 121. For example, each zone can includes one or more tag readers that potentially interfere with each other when communicating with target devices (e.g., RFID tags) in a respective monitored region.

In the context of the present example, zone 105-1 includes tag reader 121-1, tag reader 121-2, . . . , tag reader 121-N. Zone 105-2 includes tag reader 122-1, tag reader 122-2, . . . , tag reader 122-M.

In one embodiment, each of tag readers 121 can be configured to communicate with different types of target wireless devices within a respective zone. For example, each of tag readers 121 may communicate with a subset of target wireless devices including passive RFID tags, semi-passive RFID tags, active RFID tags, Wi-Fi tags, Bluetooth clients or devices or any other type of radio frequency client. The communication may be synchronized and scheduled in such a way that different types of devices use the available spectrum by sharing the total frequency band available and by sharing the available time. In one embodiment a given time period is divided into time slots. Each type of wireless device is assigned a time slot, so that different type of devices do not transmit at the same time, thereby reducing the noise generated by each type of device and increasing the overall efficiency of spectrum utilization. By way of example, time is slotted into 5 time slots during each second. Between 0 and 19.99 milliseconds the tag reader communicates with one type of passive RFID tag, for example EPC Gen2 tags, during 20.00 to 39.99 milliseconds the tag reader communicates with a second type of passive RFID tag, for example, ISO certified tags, during 40.00 to 59.99 milliseconds the tag reader communicates with active RFID tags, during 50.00 to 79.99 milliseconds the tag reader communicates with a Wi-Fi system, for example a remote server with Wi-Fi connectivity, and finally during 80.00 to 99.99 milliseconds the tag reader communicates with a Bluetooth client, for example a sensor system with a Bluetooth interface.

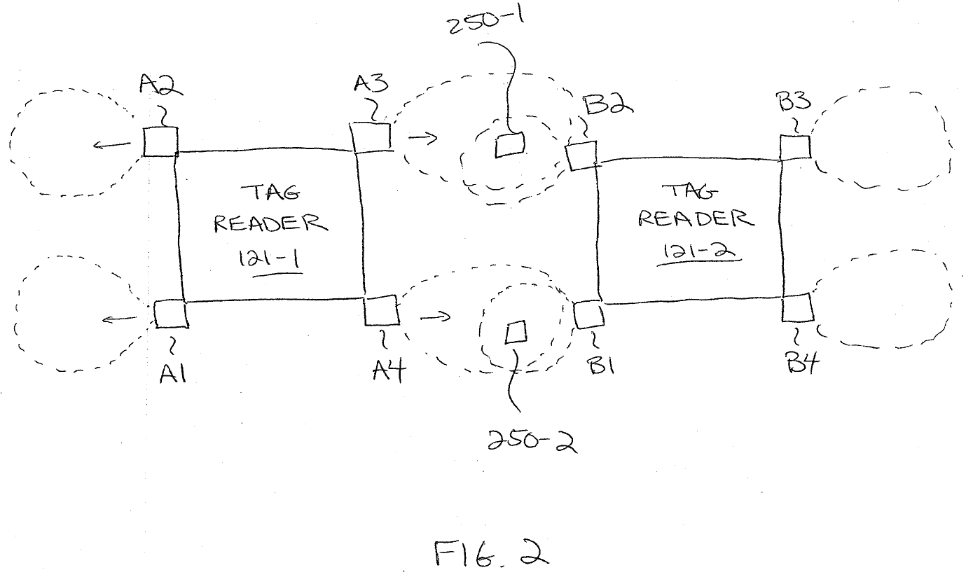

Tag readers 121 within a respective zone can be synchronized with each other to reduce interference amongst other tag readers in the respective zone. For example, as shown in FIG. 2, each tag reader 121-1, tag reader 121-2, etc. can include any number of corresponding transmitters for communicating in zone 105-1. Tag reader 121-1 includes transmitter A1, transmitter A2, transmitter A3, and transmitter A4. Tag reader 121-2 includes transmitter B1, transmitter B2, transmitter B3, and transmitter B4.

The tag readers 121 can be secured in fixed position relative to each other within a zone (e.g., a two or three dimensional space). Based on orientation and/or position of the tag reader and corresponding transmitters, certain transmitters of the respective tag readers 121 in a given zone will interfere with each other if activated simultaneously.

For example, simultaneous activation of transmitter A3 and transmitter B2 for purposes of communicating with wireless device 250-1 may result in interference due to overlapping antenna coverage areas. Simultaneous activation of transmitter A4 and transmitter B1 for purposes of communicating with wireless device 250-2 may also result in interference because of overlapping antenna coverage.

To reduce such interference and provide more efficient use of a wireless spectrum for communicating with wireless devices 250 in a monitored region (e.g., zone 105-1), embodiments herein include synchronizing tag readers 121 and/or corresponding transmitters for communicating over a shared time-based access schedule.

For example, each tag reader within a respective zone can receive synchronization information for synchronizing communications with other tag readers. The synchronization information enables the tag readers to communicate in accordance with a time-slotted schedule.

One possible embodiment of synchronizing tag readers is to use a time synchronization protocol where a single time server or set of time servers exist and the tag readers connect to the timer server(s) to get correction factors for their local clocks to the time server clock. For the case of a single time server, the role of the time server may be fulfilled by one the tag readers 121 in the zone. A direct example of a protocol is the NTP protocol, from RFC 1305. This provides timing synchronization variation of 0.5 to 50 ms, depending on network reliability and topology.

Another embodiment is to create a peer to peer network protocol based on the idea of entrainment. In this principle, oscillators that are coupled perform positive or negative feedback to move their oscillatory frequency to the average of the system. In this case, each reader will move or adjust its local clock to the instantaneous average of the population of devices. The devices will be locally synchronized, but may have a global offset from true time. This is acceptable for a single coordination zone and may also be accomplished with the NTP protocol.

A further set of embodiments focus on using information in the physical layer to provide synchronization. One example is a wired approach where the shared channel in switched Ethernet or ATM provides a local time base. Using this method, 100 ns synchronization variation has been achieved. A second example is a wireless approach, where time beacons are supplied in a server-client of peer-to-peer fashion in the wireless channel. Synchronization variation of several microseconds or less can be achieved. In yet another embodiment, tag readers 121 may be synchronized by simultaneously employing several of the above techniques.

In one embodiment, based on receipt of timing information from a source such as management system 155, respective tag readers set a system clock associated with the RFID tag reader; utilize their respective system clocks to identify a time slot in which the respective RFID tag reader is permitted to enable communications in the region via its one or more transmitters as specified by the antenna assignment information; and as will be discussed in ore detail below, initiate autonomous communications in the assigned time slots without regard to when the at least one other tag readers in zone 105-1 transmit RF energy.

The system clock is the central time reference of an RFID tag reader. Typically, a microprocessor in an embedded system has a core clock which runs the chip at a known frequency. From this core frequency, which can be several 10 s of MHz to several GHz using current technology, a system clock is defined from the core clock to keep track of the number of timer ticks (nanoseconds, microseconds or milliseconds) that have elapsed from the start of operation. The start time can be synchronized to an outside source, as described above. It is important that the system clock be stable such that the control loop algorithm that is trying to maintain synchronization between multiple tag readers can maintain a low variance.

In addition to synchronization information, each tag reader 121 can receive assignment information indicating in which of one or more time slots a corresponding transmitter 210 is permitted to transmit in zone 105-1. The assignment information can be generated locally from within a respective tag reader or received from a centralized location that assigns the transmitters to different time slots for communicating in the shared schedule (e.g., a time division multiplexed access system).

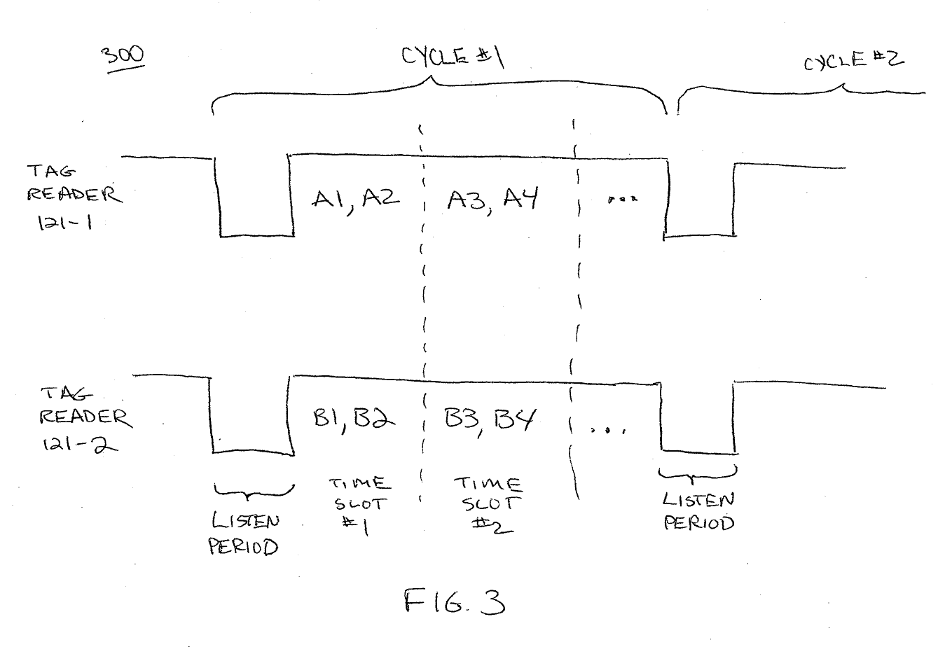

FIG. 3 is a diagram illustrating assignment of transmitters to different time slots according to embodiments herein. Each tag reader in a given zone can be configured to receive transmitter assignment information indicating in which of multiple possible time slots that corresponding antennas associated with the given RFID tag reader are permitted to transmit RF energy for communicating with RFID tags in a monitored region. Based on such assignments, the tag readers and corresponding transmitters initiate communications in permitted one or more time slots as specified by received transmitter assignment information.

As previously discussed with respect to FIG. 2, each RFID tag reader in a respective zone can include multiple transmitters or antennas on which to transmit in the zone. Each of the transmitters A1, A2, A3, A4, B1, B2, B3, and B4 can be assigned to communicate in one or more of multiple time slots of schedule 300 in FIG. 3.

In the context of the present example, assume that non-interfering transmitters A1, A2, B1, and B2 are all assigned to communicate in time slot 1. Assume also that non-interfering transmitters A3, A4, B3, and B4 are all assigned to communicate in time slot 2.

Of course, schedule 300 can include any number of time slots. Thus, the transmitters can be assigned additional time slots in which to communicate in a monitored region. Note that groups of transmitters need not be assigned the same time slots. For example, in addition to the assignment as indicated in FIG. 3 and as discussed above, transmitter A1 can be additionally assigned to time slot #3 and not time slot #4 while transmitter B1 can be assigned time slot #4 but not time slot #3.

Based on the assigned time slot information indicating in which time slots the transmitters are permitted to transmit, the tag readers can generate their own corresponding schedules for communicating in their zone. For example, tag reader 121-1 can schedule autonomous communications on transmitters A1 and A2 in time slot #1 (of cycle #1). Tag reader 121-1 can schedule autonomous communications on transmitters A3 and A4 in time slot #2 (of cycle #1). Similarly, tag reader 121-2 can schedule autonomous communications on transmitters B1 and B2 in time slot #1. Tag reader 121-2 schedules autonomous communications on transmitters B3 and B4 in time slot #2 (of cycle #1). The tag readers communicate in the permitted time slot based on a communication schedule associated with a given RFID tag reader.

In one embodiment, the transmitters can be assigned different time slots depending on a direction or coverage area in which they transmit RF energy when activated. For example, transmitters A1, A2, B1, and B2 comprise a group that are assigned a same time slot because they are more likely not going to interfere with each other as would transmitters A3 and B2.

Within a respective time slot, the transmitters are free to schedule communications at any time. Accordingly, embodiments herein enable corresponding tag readers 121 in zone 105-1 to initiate transmissions of RF energy in a permitted direction from the given tag reader during a time slot as specified by the antenna assignment information without regard to when at least one other tag reader transmits RF energy in the zone (e.g., region) during the time slot.

When executing a respective tag reader schedule, tag reader 121-1 communicates in zone 105-1 (e.g., a monitored region) via a first respective directional antenna (e.g., transmitter A1 and/or transmitter A2) during time slot #1 and communicates in zone 105-1 via a second respective directional antenna (e.g., transmitter A3 and/or transmitter A4) during time slot #2. When executing a respective tag reader schedule, tag reader 121-2 communicates in zone 105-1 via a first respective directional antenna (e.g., transmitter A1 and/or transmitter B2) during time slot #1 and communicates in zone 105-1 via a second respective directional antenna (e.g., transmitter B3 and/or transmitter B4) during time slot #2.

Accordingly, embodiments herein include one or more tag readers that each receive synchronization information; utilize the synchronization information to synchronize themselves with a set of other RFID tag readers in a zone; and initiate communications from one or more corresponding transmitters in assigned time slots as specified by corresponding transmitter time slot assignment information.

In addition to including time slots in which transmitters are permitted to communicate (e.g., transmit) in a monitored region, the schedule 300 as shown in FIG. 3 can further include a listen period in which none of the transmitters communicate in monitored region. Instead of transmitting, the tag readers utilize corresponding receivers to monitor a presence of RF energy in one or more carrier bands. Based on monitoring results, the tag readers can identify which channels are clear for communicating during respective permitted time slots. In this embodiment, the purpose of the scheduled listen period is to determine if there are other wireless transmitters operating in the monitored region who would interfere with the tag readers or whose operation would be interfered by the transmitting tag readers. The tag reader listens on a particular channel or on a multitude of channels to determine which other devices are present. Since all the tag readers are quiet, any transmission coming from other devices is clearly identifiable. Specifically the tag readers detect and down convert the received signal in a specific band to base band and subsequently analyze the collected data for its spectral content and its power levels. The analysis can be done in the frequency domain through means of Fourier Transforms or in the time domain. The analysis may be done relative to the part of the band that the tag reader transmits in (reader to tag link) or relative to the band that the tag transmits in (tag to reader link). The analysis maybe done in accordance with very specific requirements on the noise floor as far as tag reader and tag operation is concerned. For example, transmission in the reader transmit band may be relatively strong and yet not interfere with reader transmission, whereas very low noise levels in the frequency band of the tag response could substantially interfere with the tag transmission. The noise level during the listen period can be detected at the RF level, i.e. without down-conversion, or at the base band level after down conversion. It can be measured through digital signal processing or in analog components.

The noise can be generated by devices that are tag readers that don't participate in the synchronization, e.g., devices that are not controlled by the operator of tag readers 121 or by tag readers that do not possess the technical capabilities to participate in time synchronization, e.g., inexpensive mobile or fixed devices. Any set of wireless devices or system that does not participate in the synchronization (“foreign transmitters”) potentially causes unwanted interference and performance degradation. Therefore the noise coming from foreign transmitters is to be avoided in order to maintain system performance. If the tag reader does not detect any noise higher than a pre-determined threshold it can proceed to transmit in the allocated time slot. If the tag reader detects noise above the threshold, it can proceed with a number of strategies including i) switch channel, ii) switch channel and repeat the listening operation on the new channel, iii) remain quiet and repeat the listening operation at a later time, iv) transmit in the allotted time slot but adjust its transmission or receiver behavior to account for the impact of the detected interference v) adjust the time slots and transmit according to the adjusted schedule vi) share information about the detected noise with other tag readers participating in the synchronization vii) share the information about the detected noise and signals with a central controller, viii) broadcast requests and/or information about the noise or its intent to broadcast over the network, ix) share requests and/or information about the noise or its intent to broadcast wirelessly.

Tag readers may listen on a single channel, or simultaneously on multiple channels, or on any subset of the relevant frequency band. Tag reader may schedule listening on different sub bands in a time-sharing approach. In one embodiment the tag reader partitions the available listening slot into as many sub bands, say n, necessary to listen to the entire frequency band. The tag reader then listens on all n sub bands for 1/n-th the time of the entire time slot.

The tag reader may be built to listen at different power levels by virtue of building in sufficient dynamic range to listen and measure weak signals on the one hand and strong signals on the other hand. Tag readers can also be configured to analyze the received signal for purpose of determining what kind of device has emitted such signal. By way of example, a tag reader may receive a signal in the listen period and determine from the spectral content of the received signal, if it was emitted by a tag reader not participating in the synchronization, from another tag reader, or from a Wi-Fi device, etc. Based on the specific knowledge of what kind of device is transmitting the tag reader can then adjust its strategy of dealing with that device. The tag reader may use this approach also when synchronization is not available, or synchronization is temporarily not available, or synchronization does not provide sufficient time granularity or devices are mis-synchronized.

Thus, according to embodiments herein, prior to communicating in a zone (e.g., monitored region), the tag readers and corresponding receivers can be configured to monitor a corresponding portion of the zone for a presence of RF energy in a listen time slot during which the other tag readers also monitor the region for a presence of RF energy. Such a process of monitoring can include selecting a given wireless carrier band and monitoring the region for a presence of RF energy at the given wireless carrier band.

If a respective tag reader detects sub-threshold RF energy on a particular one or more monitored band, the tag reader can select such one or more bands on which to communicate during a respective time slot assignment. Accordingly, tag readers in a zone can be configured to monitoring the region for a presence of RF energy in a time slot in which the other RFID tag readers also monitor the region for a presence of RF energy; and based on different levels of RF energy detected in the monitored region in different frequency bands, selecting one or more of the different frequency bands on which to communicate in the monitored region during respective assigned time slots.

FIG. 3. shows a scenario where the scheduling of the individual tag readers (tag reader 121-1 and tag reader 121-2) includes the scheduling of a listen period at substantially the same time for tag reader 121-1 and tag reader 121-2. The purpose of the listen period is to detect transmission of other wireless devices in the monitored region or the general noise level in the monitored reasons. By scheduling the listen period at the same time, the possibility of tag reader 121-1 detecting just the transmission from tag reader 121-2 is avoided, and both tag readers can detect weaker signals from other wireless devices. Following the listen period tag reader 121-1 or tag reader 121-2 or both start communication to wireless tags in the monitored region. The scheduling at the specific time is accomplished by using the time reference information as well as information about the intended start time of a listen period that is available to tag readers 121.

In one embodiment, tag readers 121 collect received data during the listen period and perform a frequency and power analysis of the received signals. Tag readers 121 are also given threshold values for the tolerable noise level. If the detected noise level is below the threshold for an individual tag reader (e.g., as determined by its own hardware circuitry or by local radio regulations), the tag reader starts transmitting on one of its transmitters. This period is called the antenna enable period in FIG. 3. After completion of the antenna enable period the tag readers repeat the listen period at substantially the same time and a new cycle commences.

Tag reader 121-1 or tag reader 121-2 in FIG. 3 may select a specific channel or frequency band for the listen period and for the antenna enable period. In this case they detect noise or transmission on the specific channel and if the level of noise is below a certain threshold the tag readers proceed to transmit on the specific channel. If elevated levels of noise are detected on the channel, the tag reader may decide to switch channels for purpose of transmission during the antenna enable period or wait for the following listen period and monitor a different channel at that time. Alternatively the tag reader does not transmit on a channel where it has detected significant noise levels. In response to detecting the presence of the wireless transmissions or electromagnetic noise in each of multiple wireless channels in a designated frequency spectrum for communicating with the multiple wireless identification tags, a tag reader may temporarily disable subsequent communications from the given wireless transceiver device.

The selection of channels for the initial listen period, antenna enable period, and subsequent listen periods may be done according to a number of different algorithms and strategies. In one embodiment the channels are chosen so that more than one tag reader monitors and transmits on the same channel. In another embodiment channels are chosen and monitored so that no two devices occupy the same channel. In yet another embodiment the channel is selected randomly. If the tag reader detects wireless signals on a channel it then randomly selects another channel. Instead of a single listen period, the tag readers can use multiple sub periods within the listen period to monitor more than one channel. In one embodiment there are as many listen period intervals as there are available channels. The tag readers listen on all channels in sequence. Upon completion of all the listen periods, the tag reader determines which channel would be most favorable for communication with the wireless tags and then proceeds to communicate on that channel. In another embodiment, all channels are monitored at the same time using signal processing techniques such as Fourier Transforms on a frequency band encompassing more than one channel.

In some embodiments, not all tag readers may participate in time synchronization. Reasons may be a lack of technical capability, a lack of delivery of time information to certain tag readers, or a temporary inaccuracy of time reference information. The listening tag readers may be faced with a situation of classifying other tag readers as noise.

During the listen period a tag reader disables its transmitter but enables its receiver. In order for the listen period to be successful, the tag reader must reduce its output signal to a level that is below the noise level of any other RF device to be detected during the listen period. In one embodiment this is accomplished by further reducing the power leakage of the oscillator of the tag reader.

The methodology described above can be extended to incorporate two (e.g., multiple) listen periods for a given cycle, the first of which is used by a given tag reader to listen for wireless transmissions in the monitored region 105 from sources other than the multiple other tag readers, the first time duration being substantially a same time as when the multiple other tag readers also listen for wireless transmissions in the monitored region. The second listen period is used by the given tag reader to listen for wireless transmissions by the multiple other tag readers that potentially transmit in the monitored region. If these two listen periods yield no detected transmissions from foreign transmitters or any of the other multiple tag readers in the monitored region, the given tag reader initiates transmission on channels wherein no other transmission signals are detected. If, however, the given tag reader detects transmissions either within the first listen period or the second listen period, it will disable its own transmitter from initiating transmission so as to avoid collisions in the channel. Yet another embodiment of this two-stage listen strategy includes scheduling a second listen time of a random duration for the given tag reader to listen for wireless transmissions by the multiple other tag readers and scheduling the given tag reader to communicate in the monitored region after the second listen time.

The methodology described above can be further extended to as follows. Synchronizing the given tag reader causes the given it to become part of a first zone of multiple zones of synchronized tag readers, the first zone including the given tag reader and the multiple other wireless transceiver devices, a second zone of the multiple zones including a corresponding remote group of synchronized tag readers i) that operate off of a unique master clock with respect to a corresponding master clock used to synchronize the tag readers in the first zone and ii) that do not interfere with communications initiated by the tag readers in the first zone.

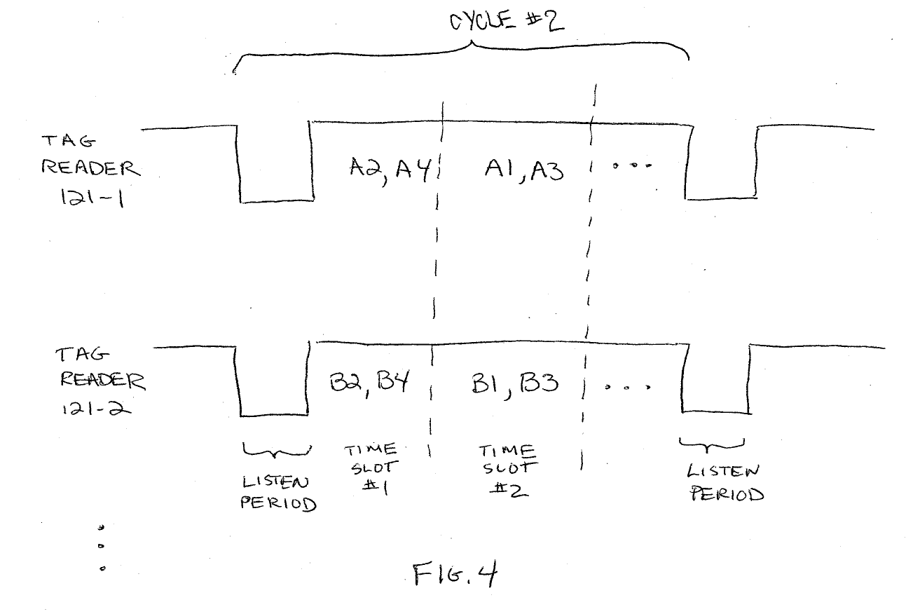

FIG. 4 is an example timing diagram illustrating diversity according to embodiments herein. As shown, assignment of transmitters to different time slots can be varied over different communication cycles of the shared time-based access schedule. Such an embodiment increases the likelihood that a respective tag reader can communicate with a respective RFID tag in the monitored region because system parameters may change over time even though a group of transmitters assigned to a given time slot can originally appear to be non-interfering but become interfering over time.

In an environment, radio frequency waves will be absorbed and scattered among different materials. The scattered waves constructively and destructively interfere but still have a strong line of sight component. This creates a static distribution of signal in the environment known as Rician fading. In an environment, as soon as material moves, as is the case in many operational environments (human, machines, air flow, etc.), the scattering pattern of the environment will change. The behavior of the room can define a coherence time where the phase relationship of the distribution at a given point in time is correlated with itself. When the coherence is lost, it could be advantageous to change the properties of the various tag readers in the environment in terms of their TDMA schedule or their transmit power to be able to optimize a system metric (e.g., overall or individual tag reader performance).

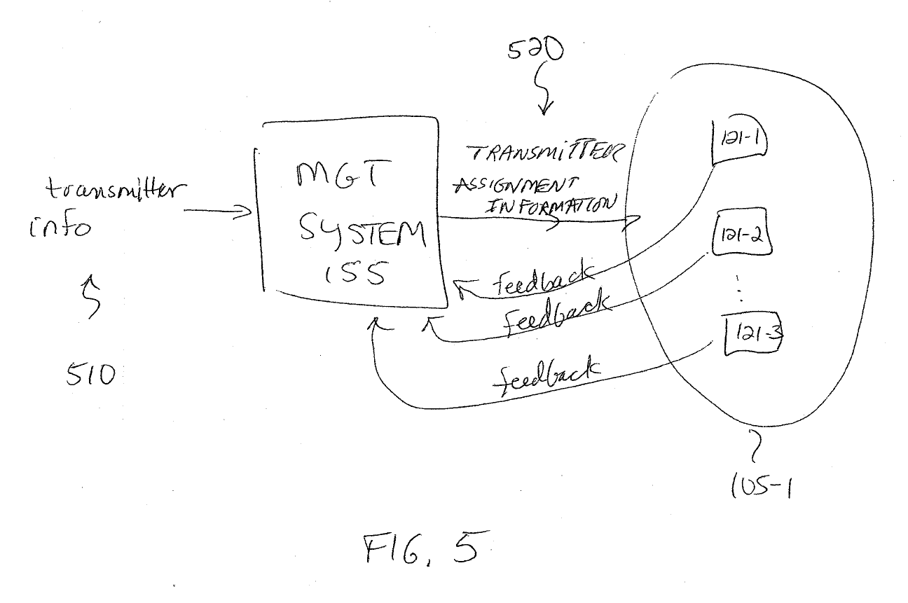

For example, a time slot assignment source such as management system 155 (FIG. 5) can initiate activation of the corresponding antennas associated with the tag readers in permitted time slots as identified by a first set of transmitter assignment information distributed to each of the tag readers. The management system 155 can then reassign one or more of transmitters associated with tag readers 121 to communicate in a different time slot in a following communication cycle of time-slotted communications. As shown in FIG. 5, an assignment authority (e.g., management system 155) assigns transmitters A2, A4, B2, and B4 to communicate in time slot #1 of cycle #2.

Thus, in one embodiment, for a first time-slotted communication cycle, a respective tag reader 121 in zone 105-1 receives a first set of antenna assignment information indicating in which of multiple possible time slots of the first time-slotted communication cycle that corresponding antennas associated with the respective RFID tag reader are permitted to transmit during execution of the first time-slotted communication cycle (as in FIG. 3); and for a second time-slotted communication cycle, the respective tag reader 121 receives a second set of antenna assignment information indicating in which of multiple possible time slots of the second time-slotted communication cycle that corresponding antennas associated with the respective RFID tag reader are permitted to transmit during execution of the second time-slotted execution cycle (FIG. 4).

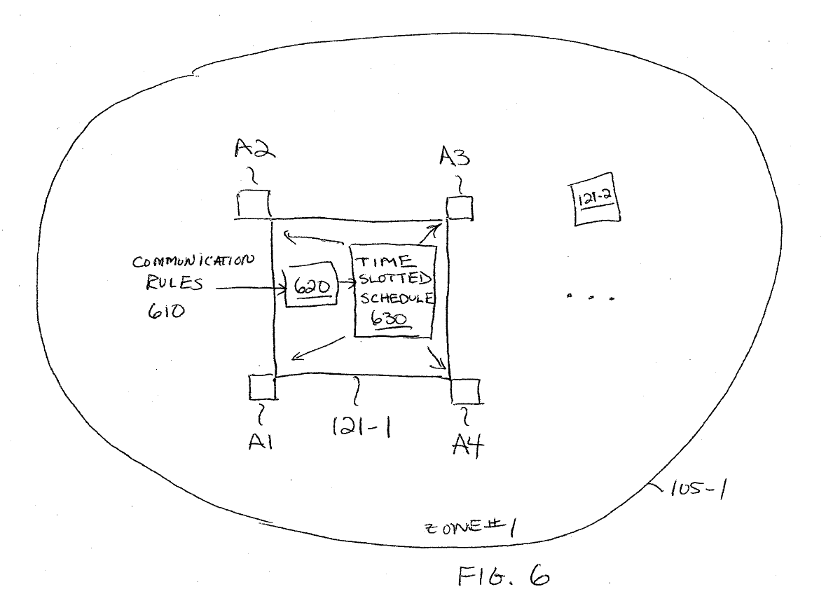

Note that a respective tag reader in a zone can receive antenna assignment information from a centralized location such as management system 155 (FIG. 1) that generates rules indicating in which of multiple time slots directional antennas associated with the tag readers 121 are permitted to communicate with respective RFID tags (or other wireless devices) in zone 105-1. This is further discussed in FIG. 5. As an alternative, the tag readers can receive a set of rules for generating transmitter time slot assignment information as will be discussed in FIG. 6.

FIG. 5 is an example diagram illustrating generation of transmitter assignment information 520 at a centralized location according to embodiments herein. As shown, management system 155 associated with zone 105-1 receives transmitter information 510 associated with multiple transmitters (e.g., transducers) that transmit RF energy in a monitored region such as zone 105-1. Based on the transmitter information 510, the management system 155 produces transmitter assignment information 520 by assigning each of the multiple transmitters in zone 105-1 (e.g., each of the transmitters associated with tag readers 121) a respective time slot for permitting transmission of RF energy in the zone 105-1. After creating the transmitter assignment information 520, the management system 155 distributes the transmitter assignment information 520 (as discussed above) to provide notification of which of multiple time slots when each of the multiple transmitters are permitted transmit the RF energy in the zone 105-1.

In one embodiment, producing the assignment information includes assigning a given transmitter of the multiple transmitters to a given time slot based at least in part on feedback from one or more tag readers The tag readers may communicate information to the centralized location about the need to communicate, the noise levels in a particular location or on a particular channel, or in a particular time interval, the effects of the noise on tag reader communication and performance, the channel allocation of the tag readers, the read success and failures in a particular slot or on a particular channel, other statistics about the reader performance, or detection of other types of devices in the read zone. Based on this information the centralized location may communicate specific channel and slot information to the tag readers. By way of example, tag reader 121-1 reports elevated noise levels on channel 1. Tag reader 121-2 is located close to tag reader A. The centralized location instructs tag reader 121-1 and tag reader 121-2 to use channel 2. However, the centralized location can choose a number of instructions relative to anyone of the tag readers including: i) initiate transmission on a different channel, ii) remain quiet until the noise environment in the monitored region changes or the tag reader report new information, iii) transmit in the allotted time slot but adjust its transmission or receiver behavior to account for the impact of the detected interference iv) adjust the time slots and transmit according to the adjusted schedule v) share information about the detected noise with tag readers participating in the synchronization so that such tag readers are enabled to act on the information vi) share the information about the detected noise and signals with other centralized devices or controllers, vii) broadcast requests and/or information about the noise or other information over the network, viii) share requests and/or information about the noise or the intent of a tag reader to transmit wirelessly.

As discussed above, the management system 155 can assign a subset of the multiple transmitters to communicate in a same time slot of a time-based channel access schedule. The transmitter information 510 can include transmitter coverage information (e.g., directional information, etc.) specifying in which direction the respective transmitters transmit RF energy when activated. Accordingly, the management system can group and assign transmitters that transmit in a same direction to a same time slot. Transmitter information 510 may include other types of information, such as types of devices in the are covered by a transmitter, power-levels of a transmitter, presence of RFID tags and other devices in the area covered by a transmitter, relative distance between pairs of transmitters, interference levels between pairs of transmitters, gain levels, beamwidth or other electrical specification of the transmitters, near-field characteristics of transmitters, or far field characteristics of transmitters. Transmitter information 510 may also include information about the application requirements of a specific transmitter. For example, a transmitter may have certain duty cycle requirements, or a transmitter operates only in the event of an external trigger, or a transmitter operates only if it detects the presence of at least one wireless tag in the area, or a transmitter is required to be on continuously but at a different power level, or a transmitter is required to check for the presence of a wireless tag on a certain schedule in order to avoid missing any wireless tag. The management system uses the above information to create a schedule that accommodates any or all of these constraints with the goal of optimizing overall system performance.

The management system uses and alters a set of parameters available to optimize the system performance, including the number of time slots available, the length of each time slot, the number of different channels, the assignment of each transmitter to anyone time slot and channel. The management system can further be configured to assign specific communication parameters to each transmitter to further increase system performance, such as the specific communication power-level, the wireless protocol used, the transmission speed used, the bit rate for the transmit link, the bit rate for the receive link, the communication sub-carriers for the receive link, the modulation index, the communication duty cycle, the continuous wave time.

For example, the management system in a large retail store with a back-room warehouse assigns transmitters according to the following rules: Time is divided into 3 time slots, each of them ⅓ of a second long (Slot 1, Slot 2, Slot 3). The management system has two communication channels available (Channel A and Channel B). The transmitters are capable of transmitting at two power levels (P1 and P2). The management system provides the following instructions to the transmitters: i) all retail check-out transmitters, operate at P1 during Slot 1 and Slot 2 on Channel A ii) all transmitters installed on retail shelves, operate at P1 during Slot 3 on Channel A iii) All transmitters installed at dock doors and pointing into the door opening from the right, operate at P2 during Slot 1 on Channel B iv) all transmitters installed at dock doors and pointing into the door opening from the left, operate at P2 during Slot 2 on Channel B v) all other transmitters installed in the environment operate at P2 during Slot 3 on Channel B.

In other embodiments, the management system 155 groups and assigns time slots based on interference mitigation constraints. For example, the management system 155 selects a first subset of the multiple transmitters to produce a first group of non-interfering transmitters. The management system allocates a first time slot in which the first group of non-interfering transmitters (e.g., a grouping of transmitters that do not interfere with each other when simultaneously activated) are permitted to transmit in the monitored region. Additionally, the management system 155 selects a second subset of the multiple transmitters to produce a second group of non-interfering transducers (e.g., another grouping of transmitters that do not interfere with each other when simultaneously activated). The management system 155 allocates a second time slot in which the second group of non-interfering transducers are permitted to transmit in the monitored region.

As previously discussed, the management system 155 can implement diversity by dynamically modifying groupings of the multiple transducers that are permitted to transmit RF energy in the monitored region during a given time slot.

The transmitter information 510 received by management system 155 can include interference information indicating which of the multiple transducers interfere with each other when activated at the same time. In such an embodiment, producing the transmitter assignment information 520 can include utilizing the transmitter interference information to assign non-interfering sets of transducers to a same corresponding time slot in which a respective set of non-interfering transducers is permitted to simultaneously initiate communications in the zone 105-1.

There are a number of ways to produce the transmitter interference information. For example, the transmitter interference information can be derived via implementing a procedure in which one or more transmitters of a corresponding one or more tag readers transmits RF energy while other tag readers each monitor for a presence of RF energy produced by the at least one transducer.

This interference test procedure can be implemented before the tag readers 121 attempt to communicate with wireless devices in zone 105-1. Additionally and/or alternatively, the transmitter interference information can be derived via normal operation during which the multiple transducers are activated to transmit in respective assigned time slots.

Interference tests comprise initialization tests and run-time tests. Initialization tests are generally used to establish upper and lower bounds on the interference of a tag reader to make sure that intended operation at run-time can occur. This can be accomplished by sequentially turning on each reader at a time and having all other readers record the distribution of signal energies received. This matrix of information can be used to move specific antennas or even tag readers to locations that can minimize interference. Alternatively, all tag readers can be turned on at once and each one measures this information. This is faster, but cannot be used to diagnose certain problems. Once adequate limits are established from the physical placement of tag reader antennas, run-time maintenance of interference is required due to the multipath coherence time. One embodiment of an interference test is to measure the spectrum of interference in a spectral region of interest (i.e. where tags respond). Given that current RFID protocol are packetized transmission with short packets, the preamble of communication contains segments of time where link quality could be measured. This embodiment could be further divided into a reporting mode where the tag reader reports what it has measured to a remote or local server or management system 155 and does nothing to change its current configuration until instructed otherwise. This could further be embodied as a peer-to-peer algorithm. In another embodiment, the tag reader may be able to take action on its own, such as changing frequency (by channel), changing receiver filters in an adaptive equalization sense, or to change power levels on the transmitter or finally, receiver gain.

FIG. 6 is an example diagram illustrating generation of assignment information in a corresponding tag reader according to embodiments herein. From a priori knowledge, for example, that the direct path of interference between two line of sight antennas will be greatest, it is possible to generate a schedule to guarantee that the interference from line of sight antennas will never occur. For information about interference that is learned at run-time, this schedule must not be fixed, but created by a central controller, in a peer-to-peer or communication-less fashion. For example, a tag reader 121 receives a set of rules 610 about use of a wireless spectrum that is used to communicate from multiple transmitters of tag readers. In accordance with the rules 610, the tag reader 121 assigns the multiple transmitters of the respective tag reader to transmit in time slots of the shared time slotted access schedule as discussed above. Accordingly, each of multiple respective tag readers 121 in zone 105-1 can be configured to generate its own transmitter assignment information for scheduling communications relative to other tag readers 121.

According to one configuration, the tag reader can monitor a level of RF energy present in its corresponding zone 105-1 (e.g., monitored region). Based on the level of RF energy in the region as measured over time, the tag reader 121-1 dynamically permits use of the multiple transmitters in different time slots. In other words, the assignment function 620 tag reader 121-1 can take into account current environmental conditions (e.g., measured RF energy) in addition to rules 610 when assigning the transmitters to different time slots. Such an embodiment enables more efficient RFID tag reads by assigning the multiple transmitters in different time slots based at least in part on statistical information maintained by the given RFID tag reader.

To enhance efficiency, the tag reader 121-1 can at least occasionally introduce some level of randomness when selecting which of the multiple transmitters to assign to the different time slots. Such an embodiment can help ensure that the tag reader 121-1 is able to communicate with each RFID tag within zone 105-1. The strategy of assigning time slots, channels, communication parameters, power levels and other parameters relevant to the overall system performance may be determined and refined by a management system 155 as in FIG. 5. In this case, a hardware or software device acts as the management for a subset of the tag readers in the system, for example 121-1 and 121-2. The management system 155 can itself be a tag reader in the system or a separate hardware or software device, for example a server or a personal computer or an embedded processor or a laptop.

In a different embodiment some of the tag readers operate as their own semi-autonomous agents in determining which strategy to use to communicate and maximize overall system through put. In this case the tag reader may receive general instructions about how to schedule its transmission and listening periods and which channels to use. However, the details of the dynamic strategy can be determined by the tag reader based on the information available to it. In yet another embodiment, the tag readers are completely autonomous.

Whether the tag readers receive information from a management system, or act autonomously, or both, the management system 155 and the tag readers 121 independently can make use of software algorithms and procedures, sensing technology (“sensing technology”), and communication between the devices 155, 121-1, and 121-2 (“communication strategies”) to improve system performance as well as the performance of individual tag readers 121. Such software algorithms and procedures may run on the management system 155 or the tag readers 121. Such software algorithms and procedures can include any of the following: a) linear optimization b) nonlinear optimization, c) steepest decent, d) genetic algorithms, e) neural networks, f) algorithms based on linear or non-linear basis functions, g) Gaussian Mixture models, h) support vector machines, g) pattern recognition algorithms, etc. Such software algorithms may also include Digital Signal Processing algorithms such as Fourier Transforms, Fast Fourier Transforms, digital filters, band-pass filters, high-pass filters, low-pass filters, non-linear filters, linear filters, thresholding, dynamic threshold determination, an others.

Sensing technology as mentioned above can include, tag sensing in the form of RF energy, tag sensing at the level of the exchange of digital information, or other sensors co-located with the tag readers 121 or the management system 155 or located in other locations within the zone 105. Such other sensors can include motion sensors, light sensors, door sensors, IR sensors, RF sensors, RF probes, temperature sensors, listen before talk sensors as described in EN 302-208 regulations for operation of RFID tag readers, and RF antennas.

Communication strategies as mentioned above can include tag readers 121 sending sensing or tag reading information and results to each other or to the management system via a wired communication such as a simple wireline protocol or Ethernet or the TCP/IP protocol or IP broadcasting or a serial protocol such as USB or RS232, RS485. The communication strategy may also include communication between 121-2, 121-2, and 155 via wireless communication such as proprietary protocols or Wi-Fi, or Bluetooth, or an RFID protocol, or the Near Field Communication protocol, or a simple wireless beacon, or IR, or visible light. The means of communication outlined here may also be used to communicate static and dynamic information from the management System to the tag readers 121-1 and 121-2. In one specific embodiment the tag readers 121-1 and 121-2 periodically broadcast information to each other and/or to the management system 155 about which channels they are occupying including such information as to which antennas or transmitters are using which channel at which time or in which slot and how long the transmission is expected to last.

In one specific embodiment the tag readers 121-1 and 121-2 are given very specific instructions about slotting and listen periods. In one case two slots are allocated and the tag readers are permitted to use one of the two slots (S1 and S2) for one of two transmitters (A1 and A2) or antennas controlled by each tag reader. Initially each tag reader randomly assigns transmitter A1 and A2 to S1 and S2 (“discovery period”). A sequence of transmissions may look like the following: S1-A1, S2-A2, S1-A2, S2-A1, S1-A1, S2-A2, S1-A2, S2-A1, etc. Upon completion of the discovery period, the tag reader determines how many RFID tags is read on average in anyone of the two possible assignments of antennas and slots: S1-A1/S2-A2 and S1-A2/S2-A1. The tag reader then continues into the read period (“read period”), where the tag reader only uses the assignment that was most successful in the discovery period.

After completion of the read period the timing of which can be random the tag reader repeats the discovery period and the cycle starts all over. In this particular example the only constraint for the tag reader are the time slots which are substantially the same for all tag readers 121-1 and 121-2. The idea behind this system is that a system of tag readers as depicted in FIG. 5 over time converges to a steady state where every tag reader has found an optimal solution for itself which ultimately is also the best solution for the overall system. The above example is very simple to illustrate the principle. However, the system and algorithms can be arbitrarily complex using the various elements listed above to assure optimality in complex system deployments and application scenarios.

In another example, the tag readers 121-1 and 121-2 are scheduled to observe a listen period as shown in FIG. 4. Since the tag readers don't transmit during the listen period they can sense other devices occupying the frequency bands or the use of the relevant channels by other devices or the general noise environment. The tag readers may then communicate that information (e.g., learned transmitter interference information) to the other tag readers as well as the management system. Those other devices can include such information in their determination of the best communication strategy between the readers 121-1 and 121-2 and the wireless tags and determining the best assignments and scheduling of the transmitters.

While this invention has been particularly shown and described with references to preferred embodiments thereof, it will be understood by those skilled in the art that various changes in form and details may be made therein without departing from the spirit and scope of the invention as defined by the appended claims.

What is claimed is:

1. A method of operating a given wireless transceiver device that communicates with multiple wireless identification tags in a monitored region, the method comprising:
receiving time reference information;
based on the timing reference information, synchronizing the wireless transceiver device with multiple other wireless transceiver devices that communicate in the monitored region; and
scheduling communications from the given wireless transceiver device to at least one of the multiple wireless identification tags in the monitored region.

2. A method as in claim 1, wherein receiving time reference information occurs in response to:
initiating communications over a respective network to retrieve the time reference information from a server for purposes of synchronizing wireless transmissions from the given wireless transceiver device with respect to wireless transmissions by the multiple other wireless transceiver devices that also communicate in the monitored region.

3. A method as in claim 1, wherein receiving time reference information includes receiving the time reference information from a respective GPS (Global Positioning System) device, the method further comprising:
communicating with the GPS device to obtain respective location information for purposes of learning a respective whereabouts of the given wireless transceiver device.

4. A method as in claim 1, wherein scheduling communications includes selecting a particular one of multiple wireless channels or frequency bands as a carrier medium on which to communicate from the given wireless transceiver device to at least one of the wireless identification tags in the monitored region.

5. A method as in claim 1, wherein scheduling communications from the given wireless transceiver device includes:
scheduling the given wireless transceiver device to initiate wireless communications on a respective channel in the monitored region during a respective transmit duration in which at least one of the other wireless transceiver devices is also scheduled to transmit on the respective channel.

6. A method as in claim 5, wherein scheduling the given wireless transceiver device to initiate wireless communications on the respective channel includes:
subdividing the transmit duration to include a first part and a second part;
scheduling the given wireless transceiver device to communicate on the respective channel during the first part of the time duration exclusive of the other wireless transceiver devices; and
disabling the given wireless transceiver device from communicating during the second part of the transmit duration which is apportioned for use by at least one of the other wireless transceiver devices to communicate in the monitored region.

7. A method as in claim 1 further comprising:
scheduling a first listen time duration for the given wireless transceiver device to listen for wireless transmissions in the monitored region from sources other than the multiple other wireless transceiver devices, the first time duration being substantially a same time as when the multiple other wireless transceiver devices also listen for wireless transmissions in the monitored region;
after the first listen time duration, scheduling a second listen time of a random duration for the given wireless transceiver device to listen for wireless transmissions by the multiple other wireless transceiver devices; and
scheduling the given wireless transceiver device to communicate in the monitored region after the second listen time.

8. A method as in claim 1, wherein synchronizing the given wireless transceiver device causes the given wireless transceiver device to become part of a first zone of multiple zones of synchronized wireless transceiver devices, the first zone including the given wireless transceiver device and the multiple other wireless transceiver devices, a second zone of the multiple zones including a corresponding remote group of synchronized wireless transceiver devices i) that operate off of a unique master clock with respect to a corresponding master clock used to synchronize the wireless transceiver devices in the first zone and ii) that do not interfere with communications initiated by the wireless transceiver devices in the first zone.

9. A method as in claim 8 further comprising:
scheduling the given wireless transceiver device in the first zone to initiate wireless transmissions while i) each of the other multiple wireless transceiver devices are disabled from transmitting, and ii) each wireless transceiver device in the second zone attempts to detect the wireless transmissions from the given wireless transceiver device transmitting in the first zone.

10. A method as in claim 1 further comprising:
operating the given wireless transceiver device amongst at least one wireless transceiver device that communicates with the wireless identification tags in the monitored region but is not synchronized as part of a respective zone of synchronized wireless transceiver devices including the given wireless transceiver device and the multiple other wireless transceiver devices.

11. A method as in claim 1, wherein scheduling communications from the given wireless transceiver device includes:
utilizing the timing reference information to:
schedule a first time duration in which the given wireless transceiver device transmits an unmodulated wireless carrier signal to provide power to at least one of the multiple wireless identification tags in the monitored region;
schedule a second time duration in which the given wireless transceiver device transmits a modulated wireless carrier signal to communicate a message to the at least one wireless identification tag; and
schedule a third time duration in which the given wireless transceiver device simultaneously i) transmits the unmodulated wireless carrier signal to provide power to the at least one of the multiple wireless identification tag in the monitored region, and ii) receives a modulated signal from the wireless transceiver device to receive a response from the at least one wireless identification tag.

12. A method as in claim 1, wherein receiving time reference information includes receiving the time reference information in a form of a wireless synchronization signal.

13. A method as in claim 1, wherein more than one wireless transceiver device operates in a given region receiving different modes of time reference information synchronized to the same time reference information

14. A method as in claim 1, wherein multiple types of wireless transceivers are assigned different time slots such that only wireless transceivers of the same type transmit a during a given time slot.

15. A method as in claim 14, wherein a first type of wireless devices is assigned to communicate in a first time slot of a time slotted access schedule shared by the wireless transceiver device and the other wireless transceiver devices that communicate in the monitored region; and
wherein a second type of wireless devices is assigned to communicate in a second time slot of a time slotted access schedule.

16. A method as in claim 15, wherein the first type of wireless transceiver devices includes transmitters that make different spectral use of wireless channels than those in the second type of wireless transceiver devices.

17. A method as in claim 16, wherein the first type of wireless transceiver devices includes wireless transmitters that transmit at different respective power levels and use different communication protocols than wireless transmitters associated with the second type of wireless transceiver devices.

18. A method comprising:
receiving synchronization information;
utilizing the synchronization information to synchronize a given RFID tag reader with a set of other RFID tag readers; and
initiating communications from at least one antenna associated with the given RFID tag reader in assigned time slots.

19. A method as in claim 18 further comprising:
prior to communicating in a region, monitoring the region for a presence of RF energy.

20. A method as in claim 18 further comprising:
receiving antenna assignment information indicating in which of multiple possible time slots that corresponding antennas associated with the given RFID tag reader are permitted to transmit RF energy for communicating with RFID tags in a monitored region; and
wherein initiating the communications from the at least one antenna associated with the given RFID tag reader includes initiating communications from at least one of the corresponding antennas in a permitted time slot as specified by the antenna assignment information to communicate with the RFID tags.

21. A method as in claim 20, wherein initiating the communications includes communicating in the permitted time slot based on a communication schedule associated with the given RFID tag reader.

22. A method as in claim 18 further comprising:
receiving antenna assignment information from a centralized location that generates rules indicating in which of multiple time slots directional antennas associated with the given RFID tag reader and the set of other RFID tag readers are permitted to communicate with respective RFID tags.

23. A method as in claim 18, wherein initiating communications from the at least one antenna associated with the given RFID tag reader in assigned time slots includes:
communicating in a monitored region via a first directional antenna of the given RFID tag reader during a first time slot; and
communicating in the monitored region via a second directional antenna of the given RFID tag reader during a second time slot.

24. A method as in claim 18, wherein initiating communications from the at least one antenna associated with the given RFID tag reader in assigned time slots includes:
based on receipt of antenna assignment information, scheduling autonomous communications from a first directional antenna of the given RID tag reader during a first time slot in which multiple non-interfering antennas associated with the set of other tag readers are also permitted to communicate in the first time slot; and
based on receipt of antenna assignment information, scheduling autonomous communications from a second directional antenna of the given RFID tag reader during a second time slot in which multiple non-interfering antennas associated with the set of other tag readers are also permitted to communicate in second time slot.

25. A method as in claim 18, wherein the given RFID tag reader and set of other RFID tag readers each include multiple antennas on which to transmit in the monitored region, each of the multiple antennas being assigned for communication in one of multiple time slots.

26. A method comprising:
synchronizing a given RFID tag reader with at least one other RFID tag reader in a region, each RFID tag reader having at least one corresponding antenna to communicate in a region;
receiving antenna assignment information indicating in which of multiple possible time slots that corresponding antennas associated with the given RFID tag reader are permitted to transmit; and
utilizing the antenna assignment information to create an access schedule for the given RFID tag reader to communicate in the region.

27. A method as in claim 26 further comprising:
based on use of the access schedule for the given RFID tag reader, enabling the given RFID tag reader to communicate in the region at a same time as another RFID tag reader by enabling an antenna associated with the given RFID tag reader to communicate in the region at a same time slot as an antenna associated with the at least one other RFID tag reader.

28. A method as in claim 26, wherein synchronizing the set of RFID tag readers includes:
based on receipt of timing information, setting a system clock associated with the given RFID tag reader;
utilizing the system clock to identify a time slot in which the given RFID tag reader is permitted to communicate in the region via at least one antenna associated with the given RFID tag reader as specified by the antenna assignment information; and
initiating autonomous communications in the time slot without regard to when the at least one other RFID tag reader transmits RF energy in the region.

29. A method as in claim 26, wherein synchronizing the given RFID tag reader with at least one other RFID tag reader includes synchronizing the given RFID tag reader with a set of tag readers in a defined zone in which the set of tag readers can cause interference with each other.

30. A method as in claim 26, wherein receiving antenna assignment information includes:
for a first time-slotted communication cycle, receiving a first set of antenna assignment information indicating in which of multiple possible time slots of the first time-slotted communication cycle that corresponding antennas associated with the given RFID tag reader are permitted to transmit during execution of the first time-slotted communication cycle; and
for a second time-slotted communication cycle, receiving a second set of antenna assignment information indicating in which of multiple possible time slots of the second time-slotted communication cycle that corresponding antennas associated with the given RFID tag reader are permitted to transmit during execution of the second time-slotted execution cycle.

31. A method as in claim 26 further comprising:
initiating activation of the corresponding antennas associated with the given RFID tag reader in permitted time slots as identified by the antenna assignment information; and
reassigning at least one of the corresponding antennas to communicate in a different time slot in a following communication cycle of time-slotted communications.

32. A method as in claim 26 further comprising:
initiating transmissions of RF energy in a permitted direction from the given tag reader during a time slot as specified by the antenna assignment information without regard to when the at least one other RFID tag reader transmits RF energy in the region during the time slot.

33. A method comprising:
receiving transmitter information associated with multiple transducers that transmit RF energy in a monitored region;
based on the transmitter information, producing assignment information by assigning each of the multiple transducers a respective time slot for permitting transmission of RF energy in the monitored region; and
distributing the antenna assignment information to provide notification of which of multiple time slots when each of the multiple transducers are permitted to transmit the RF energy in the region.

34. A method as in claim 33, wherein producing the assignment information includes:
assigning a given transducer of the multiple transducers to a given time slot of multiple time slots based on feedback from at least one RFID tag readers that utilize the transducers to communicate with RFID tags in the monitored region.

35. A method as in claim 33, wherein producing the assignment information includes:
assigning a subset of the multiple transducers to communicate in a same time slot of a time-based channel access schedule in which the subset of multiple transducers communicate with RFID tags in the monitored region.

36. A method as in claim 33, wherein receiving coverage information includes receiving transducer information specifying corresponding directions in which the multiple transducers transmit RF energy in the monitored region.

37. A method as in claim 36, wherein producing assignment information includes:
selecting a first subset of the multiple transducers to produce a first group of non-interfering transducers;
allocating a first time slot in which the first group of non-interfering transducers are permitted to transmit in the monitored region;
selecting a second subset of the multiple transducers to produce a second group of non-interfering transducers; and
allocating a second time slot in which the second group of non-interfering transducers are permitted to transmit in the monitored region.

38. A method as in claim 33, wherein producing the assignment information includes:
providing diversity by dynamically modifying a grouping of the multiple transducers that are permitted to transmit RF energy in the monitored region during a given time slot.

39. A method as in claim 33, wherein receiving transmitter information includes receiving interference information indicating which of the multiple transducers interfere with each other when activated at the same time; and
wherein producing the assignment information includes utilizing the interference information to assign non-interfering sets of transducers to a same corresponding time slot in which a respective set of non-interfering transducers is permitted to simultaneously initiate communications in the region.

40. A method as in claim 39 further comprising:
deriving the interference information via implementing a procedure in which at least one transducer of a corresponding RFID tag reader transmits RF energy while other RFID tag readers each monitor for a presence of RF energy produced by the at least one transducer.

41. A method as in claim 39 further comprising:
deriving the interference information via normal operation during which the multiple transducers are activated to transmit in respective assigned time slots to communicate with RFID tags in the monitored region.

42. A method comprising:
synchronizing a given RFID tag reader with other RFID tag readers;
receiving a set of rules about use of a wireless spectrum to communicate from multiple transmitters associated with the given RFID tag reader; and
in accordance with the set of rules, assigning the multiple transmitters of the given RFID tag reader to transmit in time slots of a shared time slotted access schedule, the shared time slotted access schedule used by the given RFID tag reader and the other RFID tag readers to communicate in a monitored region.

43. A method as in claim 42, wherein assigning the multiple transmitters of the given RFID tag reader to transmit in the time slots includes:
enabling more efficient RFID tag reads by assigning the multiple transmitters in different time slots based at least in part on statistical information maintained by the given RFID tag reader.

44. A method as in claim 42, wherein assigning the multiple transmitters of the given RFID tag reader to transmit in the time slots includes:
at least occasionally introducing a level of randomness when selecting which of the multiple transmitters to assign to the time slots.

45. A computer system comprising:
a processor;
a memory unit that stores instructions associated with code executed by the processor; and
an interconnect coupling the processor and the memory unit, enabling the computer system to execute the code and perform operations of:
receiving time reference information;
based on the timing reference information, synchronizing the wireless transceiver device with multiple other wireless transceiver devices that communicate in the monitored region; and
scheduling communications from the given wireless transceiver device to at least one of the multiple wireless identification tags in the monitored region.

46. A computer system as in claim 45, wherein receiving time reference information occurs in response to:
initiating communications over a respective network to retrieve the time reference information from a server for purposes of synchronizing wireless transmissions from the given wireless transceiver device with respect to wireless transmissions by the multiple other wireless transceiver devices that also communicate in the monitored region.

47. A computer system as in claim 45, wherein receiving time reference information includes receiving the time reference information from a respective GPS (Global Positioning System) device, the computer system further supporting operations of:
communicating with the GPS device to obtain respective location information for purposes of learning a respective whereabouts of the given wireless transceiver device.

48. A computer system as in claim 45, wherein scheduling communications includes selecting a particular one of multiple wireless channels or frequency bands as a carrier medium on which to communicate from the given wireless transceiver device to at least one of the wireless identification tags in the monitored region.

49. A computer system as in claim 45, wherein scheduling communications from the given wireless transceiver device includes:
scheduling the given wireless transceiver device to initiate wireless communications on a respective channel in the monitored region during a respective transmit duration in which at least one of the other wireless transceiver devices is also scheduled to transmit on the respective channel.

50. A computer system as in claim last 49, wherein scheduling the given wireless transceiver device to initiate wireless communications on the respective channel includes:
subdividing the transmit duration to include a first part and a second part;
scheduling the given wireless transceiver device to communicate on the respective channel during the first part of the time duration exclusive of the other wireless transceiver devices; and
disabling the given wireless transceiver device from communicating during the second part of the transmit duration which is apportioned for use by at least one of the other wireless transceiver devices to communicate in the monitored region.

51. A computer system as in claim 45, wherein synchronizing the given wireless transceiver device causes the given wireless transceiver device to become part of a first zone of multiple zones of synchronized wireless transceiver devices, the first zone including the given wireless transceiver device and the multiple other wireless transceiver devices, a second zone of the multiple zones including a corresponding remote group of synchronized wireless transceiver devices i) that operate off of a unique master clock with respect to a corresponding master clock used to synchronize the wireless transceiver devices in the first zone and ii) that do not interfere with communications initiated by the wireless transceiver devices in the first zone.

52. A computer system as in claim 51 further supporting operations of:
scheduling the given wireless transceiver device in the first zone to initiate wireless transmissions while i) each of the other multiple wireless transceiver devices are disabled from transmitting, and ii) each wireless transceiver device in the second zone attempts to detect the wireless transmissions from the given wireless transceiver device transmitting in the first zone.

53. A computer system as in claim 45 further supporting operations of:
operating the given wireless transceiver device amongst at least one wireless transceiver device that communicates with the wireless identification tags in the monitored region but is not synchronized as part of a respective zone of synchronized wireless transceiver devices including the given wireless transceiver device and the multiple other wireless transceiver devices.

54. A computer system as in claim 45, wherein scheduling communications from the given wireless transceiver device includes:
utilizing the timing reference information to:
schedule a first time duration in which the given wireless transceiver device transmits an unmodulated wireless carrier signal to provide power to at least one of the multiple wireless identification tags in the monitored region;
schedule a second time duration in which the given wireless transceiver device transmits a modulated wireless carrier signal to communicate a message to the at least one wireless identification tag; and
schedule a third time duration in which the given wireless transceiver device simultaneously i) transmits the unmodulated wireless carrier signal to provide power to the at least one of the multiple wireless identification tag in the monitored region, and ii) receives a modulated signal from the wireless transceiver device to receive a response from the at least one wireless identification tag.

55. A computer system as in claim 45, wherein receiving time reference information includes receiving the time reference information in a form of a wireless synchronization signal.

56. A computer system as in claim 45, wherein more than one wireless transceiver device operates in a given region receiving different modes of time reference information synchronized to the same time reference information

57. A computer system as in claim 45, wherein multiple types of wireless transceivers are assigned different time slots such that only wireless transceivers of the same type transmit a during a given time slot.

58. A computer system as in claim last 57, wherein a first type of wireless devices is assigned to communicate in a first time slot of a time slotted access schedule shared by the wireless transceiver device and the other wireless transceiver devices that communicate in the monitored region; and
wherein a second type of wireless devices is assigned to communicate in a second time slot of a time slotted access schedule.

59. A computer system as in claim 57, wherein the first type of wireless transceiver devices includes transmitters that make different spectral use of wireless channels than those in the second type of wireless transceiver devices.

60. A computer system as in claim 59, wherein the first type of wireless transceiver devices includes wireless transmitters that transmit at different respective power levels and use different communication protocols than wireless transmitters associated with the second type of wireless transceiver devices.

61. A computer system comprising:
a processor;
a memory unit that stores instructions associated with code executed by the processor; and
an interconnect coupling the processor and the memory unit, enabling the computer system to execute the code and perform operations of:
receiving synchronization information;
utilizing the synchronization information to synchronize a given RFID tag reader with a set of other RFID tag readers; and
initiating communications from at least one antenna associated with the given RFID tag reader in assigned time slots.

62. A computer system as in claim 61 further supporting operations of:
receiving antenna assignment information indicating in which of multiple possible time slots that corresponding antennas associated with the given RFID tag reader are permitted to transmit RF energy for communicating with RFID tags in a monitored region; and
wherein initiating the communications from the at least one antenna associated with the given RFID tag reader includes initiating communications from at least one of the corresponding antennas in a permitted time slot as specified by the antenna assignment information to communicate with the RFID tags.

63. A computer system as in claim 62, wherein initiating the communications includes communicating in the permitted time slot based on a communication schedule associated with the given RFID tag reader.

64. A computer system as in claim 61 further supporting operations of:
receiving antenna assignment information from a centralized location that generates rules indicating in which of multiple time slots directional antennas associated with the given RFID tag reader and the set of other RFID tag readers are permitted to communicate with respective RFID tags.

65. A computer system as in claim 61, wherein initiating communications from the at least one antenna associated with the given RFID tag reader in assigned time slots includes:
communicating in a monitored region via a first directional antenna of the given RFID tag reader during a first time slot; and
communicating in the monitored region via a second directional antenna of the given RFID tag reader during a second time slot.

66. A computer system as in claim 61, wherein initiating communications from the at least one antenna associated with the given RFID tag reader in assigned time slots includes:
based on receipt of antenna assignment information, scheduling autonomous communications from a first directional antenna of the given RFID tag reader during a first time slot in which multiple non-interfering antennas associated with the set of other tag readers are also permitted to communicate in the first time slot; and
based on receipt of antenna assignment information, scheduling autonomous communications from a second directional antenna of the given RFID tag reader during a second time slot in which multiple non-interfering antennas associated with the set of other tag readers are also permitted to communicate in second time slot.

67. A computer system as in claim 61, wherein the given RFID tag reader and set of other RFID tag readers each include multiple antennas on which to transmit in the monitored region, each of the multiple antennas being assigned for communication in one of multiple time slots.

68. A computer system comprising:
a processor;
a memory unit that stores instructions associated with code executed by the processor; and
an interconnect coupling the processor and the memory unit, enabling the computer system to execute the code and perform operations of:
synchronizing a given RFID tag reader with at least one other RFID tag reader in a region, each RFID tag reader having at least one corresponding antenna to communicate in a region;
receiving antenna assignment information indicating in which of multiple possible time slots that corresponding antennas associated with the given RFID tag reader are permitted to transmit; and
utilizing the antenna assignment information to create an access schedule for the given RFID tag reader to communicate in the region.

69. A computer system as in claim 68 further supporting operations of:
based on use of the access schedule for the given RFID tag reader, enabling the given RFID tag reader to communicate in the region at a same time as another RFID tag reader by enabling an antenna associated with the given RFID tag reader to communicate in the region at a same time slot as an antenna associated with the at least one other RFID tag reader.

70. A computer system as in claim 68, wherein synchronizing the set of RFID tag readers includes:
based on receipt of timing information, setting a system clock associated with the given RFID tag reader;
utilizing the system clock to identify a time slot in which the given RFID tag reader is permitted to communicate in the region via at least one antenna associated with the given RFID tag reader as specified by the antenna assignment information; and
initiating autonomous communications in the time slot without regard to when the at least one other RFID tag reader transmits RF energy in the region.

71. A computer system as in claim 68, wherein synchronizing the given RFID tag reader with at least one other RFID tag reader includes synchronizing the given RFID tag reader with a set of tag readers in a defined zone in which the set of tag readers can cause interference with each other.

72. A computer system as in claim 68, wherein receiving antenna assignment information includes:
for a first time-slotted communication cycle, receiving a first set of antenna assignment information indicating in which of multiple possible time slots of the first time-slotted communication cycle that corresponding antennas associated with the given RFID tag reader are permitted to transmit during execution of the first time-slotted communication cycle; and
for a second time-slotted communication cycle, receiving a second set of antenna assignment information indicating in which of multiple possible time slots of the second time-slotted communication cycle that corresponding antennas associated with the given RFID tag reader are permitted to transmit during execution of the second time-slotted execution cycle.

73. A computer system as in claim 68 further supporting operations of:
initiating activation of the corresponding antennas associated with the given RFID tag reader in permitted time slots as identified by the antenna assignment information; and
reassigning at least one of the corresponding antennas to communicate in a different time slot in a following communication cycle of time-slotted communications.

74. A computer system as in claim 68 further supporting operations of:
initiating transmissions of RF energy in a permitted direction from the given tag reader during a time slot as specified by the antenna assignment information without regard to when the at least one other RFID tag reader transmits RF energy in the region during the time slot.

75. A computer system comprising:
a processor;
a memory unit that stores instructions associated with code executed by the processor; and
an interconnect coupling the processor and the memory unit, enabling the computer system to execute the code and perform operations of:
receiving transmitter information associated with multiple transducers that transmit RF energy in a monitored region;
based on the transmitter information, producing assignment information by assigning each of the multiple transducers a respective time slot for permitting transmission of RF energy in the monitored region; and
distributing the antenna assignment information to provide notification of which of multiple time slots when each of the multiple transducers are permitted to transmit the RF energy in the region.

76. A computer system as in claim 75, wherein producing the assignment information includes:
assigning a given transducer of the multiple transducers to a given time slot of multiple time slots based on feedback from at least one RFID tag readers that utilize the transducers to communicate with RFID tags in the monitored region.

77. A computer system as in claim 75, wherein producing the assignment information includes:
assigning a subset of the multiple transducers to communicate in a same time slot of a time-based channel access schedule in which the subset of multiple transducers communicate with RFID tags in the monitored region.

78. A computer system as in claim 75, wherein receiving coverage information includes receiving transducer information specifying corresponding directions in which the multiple transducers transmit RF energy in the monitored region.

79. A computer system as in claim 78, wherein producing assignment information includes:
selecting a first subset of the multiple transducers to produce a first group of non-interfering transducers;
allocating a first time slot in which the first group of non-interfering transducers are permitted to transmit in the monitored region;
selecting a second subset of the multiple transducers to produce a second group of non-interfering transducers; and
allocating a second time slot in which the second group of non-interfering transducers are permitted to transmit in the monitored region.

80. A computer system as in claim 75, wherein producing the assignment information includes:
providing diversity by dynamically modifying a grouping of the multiple transducers that are permitted to transmit RF energy in the monitored region during a given time slot.

81. A computer system as in claim 75, wherein receiving transmitter information includes receiving interference information indicating which of the multiple transducers interfere with each other when activated at the same time; and
wherein producing the assignment information includes utilizing the interference information to assign non-interfering sets of transducers to a same corresponding time slot in which a respective set of non-interfering transducers is permitted to simultaneously initiate communications in the region.

82. A computer system as in claim 81 further supporting operations of:
deriving the interference information via implementing a procedure in which at least one transducer of a corresponding RFID tag reader transmits RF energy while other RFID tag readers each monitor for a presence of RF energy produced by the at least one transducer.

83. A computer system as in claim 81 further supporting operations of:
deriving the interference information via normal operation during which the multiple transducers are activated to transmit in respective assigned time slots to communicate with RFID tags in the monitored region.

84. A computer system comprising:
a processor;
a memory unit that stores instructions associated with code executed by the processor; and
an interconnect coupling the processor and the memory unit, enabling the computer system to execute the code and perform operations of:
synchronizing a given RFID tag reader with other RFID tag readers;
receiving a set of rules about use of a wireless spectrum to communicate from multiple transmitters associated with the given RFID tag reader; and
in accordance with the set of rules, assigning the multiple transmitters of the given RFID tag reader to transmit in time slots of a shared time slotted access schedule, the shared time slotted access schedule used by the given RFID tag reader and the other RFID tag readers to communicate in a monitored region.

85. A computer system as in claim 84, wherein assigning the multiple transmitters of the given RFID tag reader to transmit in the time slots includes:
enabling more efficient RFID tag reads by assigning the multiple transmitters in different time slots based at least in part on statistical information maintained by the given RFID tag reader.

86. A computer system as in claim 84, wherein assigning the multiple transmitters of the given RFID tag reader to transmit in the time slots includes:
at least occasionally introducing a level of randomness when selecting which of the multiple transmitters to assign to the time slots.

87. Software encoded in one or more computer-readable media and, when executed, operable to:
receive time reference information;
based on the timing reference information, synchronize the wireless transceiver device with multiple other wireless transceiver devices that communicate in the monitored region; and
schedule communications from the given wireless transceiver device to at least one of the multiple wireless identification tags in the monitored region.

88. Software encoded in one or more computer-readable media and, when executed, operable to:
receive synchronization information;
utilize the synchronization information to synchronize a given RFID tag reader with a set of other RFID tag readers; and
initiate communications from at least one antenna associated with the given RFID tag reader in assigned time slots.

89. Software encoded in one or more computer-readable media and, when executed, operable to:
synchronize a given RFID tag reader with at least one other RFID tag reader in a region, each RFID tag reader having at least one corresponding antenna to communicate in a region;
receive antenna assignment information indicating in which of multiple possible time slots that corresponding antennas associated with the given RFID tag reader are permitted to transmit; and
utilize the antenna assignment information to create an access schedule for the given RFID tag reader to communicate in the region.

90. Software encoded in one or more computer-readable media and, when executed, operable to:
receive transmitter information associated with multiple transducers that transmit RF energy in a monitored region;
based on the transmitter information, produce assignment information by assigning each of the multiple transducers a respective time slot for permitting transmission of RF energy in the monitored region; and
distribute the antenna assignment information to provide notification of which of multiple time slots when each of the multiple transducers are permitted transmit the RF energy in the region.
